(19) United States
(12) Patent Application Publication
(10) Pub. No.: US 2024/0253157 A1
(43) Pub. Date: Aug. 1, 2024

(54) METHOD AND APPARATUS FOR MODIFYING A SUBSTRATE

(71) Applicant: Intel Corporation, Santa Clara, CA (US)

(72) Inventors: Richard Laming, Santa Clara, CA (US); Nicholas D. Psaila, Lanark (GB)

(73) Assignee: Intel Corporation, Santa Clara, CA (US)

(21) Appl. No.: 18/565,408

(22) PCT Filed: Aug. 5, 2022
(86) PCT No.: PCT/GB2022/052060

§ 371 Date: Nov. 29, 2023

(30) Foreign Application Priority Data
Aug. 24, 2021 (GB) 2112125.6

(51) Int. Cl. B23K 26/082; B23K 26/06; B23K 26/0622; B23K 26/70; B23K 103/00

(52) U.S. Cl. CPC B23K 26/082; B23K 26/0622; B23K 26/0648; B23K 26/705; B23K 2103/52; B23K 2103/54

(57) ABSTRACT

The present application relates to a method for modifying a substrate, which comprises generating a pulsed laser beam comprising a train of laser pulses, the train of laser pulses including at least three consecutive laser pulses, and controlling a direction of the pulsed laser beam and/or a position of the substrate from laser pulse to laser pulse so that the at least three consecutive laser pulses sequentially irradiate at least three regions of the substrate according to a predetermined spatial sequence which defines the relative spatial positions of the at least three regions of the substrate and the order of irradiation of the at least three regions of the substrate. The present application relates also to an apparatus (100) for modifying a substrate (108). The method and apparatus (100) may be used, in particular though not exclusively, for forming an optical device.

### FIELD

The present disclosure relates to a method and apparatus for modifying a substrate using a pulsed laser beam and, in particular though not exclusively, for use in forming an optical device.

### BACKGROUND

It is known to use a laser processing method to modify a substrate or a body comprising a material such as fused silica by irradiating the substrate with a pulsed laser beam. The pulsed laser beam may be used to irradiate one or more localised regions or volumes of the substrate to thereby modify the one or more irradiated regions or volumes. For example, it is known to irradiate a region of a substrate with a pulsed laser beam so as to modify a refractive index of the material of the substrate in the irradiated region. It is also known to irradiate a region of a substrate with a pulsed laser beam so as to modify a chemical etchability of the material of the substrate in the irradiated region. This may enable 3D micromachining of the substrate using a chemical etching step which follows irradiation of the substrate with the pulsed laser beam. It is also known to irradiate a region of a substrate with a pulsed laser beam so as to ablate at least some of the material of the substrate in the irradiated region.

For some applications, it is known to irradiate a plurality of regions of a substrate so as to modify the material of the substrate according to a desired spatial profile by moving the pulsed laser beam and the substrate relative to one another. To modify the material of the substrate according to a desired spatial profile whilst avoiding damaging the substrate unduly requires that the characteristics of the pulsed laser beam and the relative movement between the pulsed laser beam and the substrate are controlled carefully for compliance with a set of laser processing conditions or rules i.e. so that the characteristics of the pulsed laser beam and the relative movement between the pulsed laser beam and the substrate fall within a predetermined laser processing conditions window.

However, for a given predetermined laser processing conditions window, the throughput of such known laser processing methods for modifying a plurality of regions of a substrate may be limited.

### SUMMARY

According to an aspect of the present disclosure, there is provided a method of modifying a substrate, the method comprising:
generating a pulsed laser beam comprising a train of laser pulses, the train of laser pulses including at least three consecutive laser pulses; and
controlling a direction of the pulsed laser beam and/or a position of the substrate from laser pulse to laser pulse so that the at least three consecutive laser pulses sequentially irradiate at least three regions of the substrate according to a predetermined spatial sequence which defines the relative spatial positions of the at least three regions of the substrate and the order of irradiation of the at least three regions of the substrate.

Optionally, the at least three regions of the substrate are different, distinct and/or non-overlapping regions of the substrate.

Such a method may enable the substrate to be modified according to a desired spatial profile at higher laser pulse repetition rates than prior art methods without unduly damaging the substrate. Such a method may allow the substrate to be modified more rapidly than prior art methods thereby achieving a higher laser processing throughput.

The method may comprise irradiating the substrate with the pulsed laser beam to modify a refractive index of a material of the substrate.

The method may comprise irradiating the substrate with the pulsed laser beam to modify a chemical etchability of the material of the substrate. The method may comprise exposing the substrate to a chemical etchant after irradiation of the substrate with the pulsed laser beam.

The method may comprise irradiating the substrate with the pulsed laser beam to ablate the material of the substrate.

The method may comprise controlling one or more characteristics of the pulsed laser beam.

The method may comprise controlling one or more of an energy of each pulse within the pulsed laser beam, a repetition rate of the pulsed laser beam, a pulse duration, a wavelength of the pulsed laser beam, a polarisation of the pulsed laser beam.

The pulsed laser beam may comprise visible light or non-visible light. For example, the pulsed laser beam may comprise one or more of infra-red light, visible light, or ultraviolet light.

The pulsed laser beam may have a wavelength which is greater than 400 nm. For example, the pulsed laser beam may have a wavelength which is substantially equal to 520 nm, 800 nm, 1035 nm or 1550 nm.

The substrate may comprise a material such as a dielectric material that is at least partially transparent to the pulsed laser beam. For example, the substrate may comprise a glass or glass ceramic material such as fused silica, silicates, borosilicates, aluminosilicates, doped or modified silicates, phosphate glasses, doped or modified phosphates, chalcogenide glasses, doped or modified chalcogenides. The substrate may comprise a material other than a glass. The substrate may comprise a crystalline material such as quartz, lithium niobate, yttrium aluminium garnet or a doped, poled, or modified crystal such as periodically poled lithium niobate or neodymium doped yttrium aluminium garnet, a laser or amplifier gain medium such as a rare earth doped glass or crystal.

Optionally, controlling the direction of the pulsed laser beam and/or the position of the substrate from laser pulse to laser pulse so that the at least three consecutive laser pulses sequentially irradiate at least three regions of the substrate according to the predetermined spatial sequence comprises synchronising a movement of the pulsed laser beam and/or of the substrate with the timing of the at least three consecutive laser pulses so that the at least three regions of the substrate are sequentially irradiated with the at least three consecutive laser pulses according to the predetermined spatial sequence. This may enable the positions of the at least three irradiated regions of the substrate to be more accurately controlled.

Optionally, controlling the direction of the pulsed laser beam and/or the position of the substrate from laser pulse to laser pulse so that the at least three consecutive laser pulses sequentially irradiate at least three regions of the substrate according to the predetermined spatial sequence comprises:
controlling movement of the pulsed laser beam and/or of the substrate so as to move a nominal writing position of the pulsed laser beam to a first position in the substrate so that a first one of the at least three consecutive laser pulses irradiates a first region of the substrate centred on the first position;
controlling movement of the pulsed laser beam and/or of the substrate so as to move the nominal writing position of the pulsed laser beam across the substrate along a first direction from the first position in the substrate to a second position in the substrate so that a second one of the at least three consecutive laser pulses irradiates a second region of the substrate centred on the second position; and
controlling movement of the pulsed laser beam and/or of the substrate so as to move the nominal writing position of the pulsed laser beam across the substrate along a second direction from the second position in the substrate to a third position in the substrate so that a third one of the at least three consecutive laser pulses irradiates a third region of the substrate centred on the third position,
wherein the first and second directions are different.

Optionally, the first, second and third regions of the substrate are different, distinct and/or non-overlapping regions of the substrate.

Optionally, the first, second and third positions in the substrate are different positions in the substrate.

Optionally, wherein the third region of the substrate is located closer to the first region than the second region.

Optionally, wherein the third region of the substrate is located between the first and second regions of the substrate.

Optionally, the method comprises irradiating any two nearest-neighbour regions of the substrate using laser pulses which are separated by a time period which is greater than or equal to a predetermined minimum time period.

The minimum time period may be chosen for compliance of the method with a predetermined laser processing conditions window.

The predetermined minimum time period may be chosen so that the temperatures of said any two nearest-neighbour regions of the substrate are less than or equal to a predetermined threshold temperature.

The characteristics of the laser pulses of the pulsed laser beam may be selected so that that irradiation of a region of the substrate with a laser pulse results in multi-photon absorption of the laser pulse in the material of the substrate in the irradiated region and heating of the material of the substrate in the irradiated region. The resulting heat energy, which is generated in the irradiated region, diffuses from the irradiated region through the substrate such that the irradiated region cools over time. Accordingly, choosing the predetermined minimum time period so that the temperatures of said any two nearest-neighbour regions of the substrate are less than or equal to a predetermined threshold temperature may ensure that the method complies with the predetermined laser processing conditions window thereby enabling the substrate to be modified according to a desired spatial profile at a higher laser pulse repetition rate than prior art methods without unduly damaging the substrate.

Optionally, the method comprises irradiating any two regions of the substrate with consecutive laser pulses, wherein said any two regions of the substrate are separated by a distance which is greater than or equal to a predetermined minimum spatial separation.

The minimum spatial separation may be chosen for compliance of the method with a predetermined laser processing conditions window.

The predetermined minimum spatial separation may be chosen so that the temperatures of said any two regions of the substrate are less than or equal to a predetermined threshold temperature.

The characteristics of the laser pulses of the pulsed laser beam may be selected so that that irradiation of a region of the substrate with a laser pulse results in multi-photon absorption of the laser pulse in the material of the substrate in the irradiated region and heating of the material of the substrate in the irradiated region. The resulting heat energy, which is generated in the irradiated region, diffuses from the irradiated region through the substrate such that the irradiated region cools over time. Accordingly, choosing the predetermined minimum spatial separation so that the temperatures of said any two regions of the substrate exceed a predetermined threshold temperature may ensure that the method complies with the predetermined laser processing conditions window thereby enabling the substrate to be modified according to a desired spatial profile at a higher laser pulse repetition rate than prior art methods without unduly damaging the substrate.

The at least three regions of the substrate may be arranged in an array such as a 1D array, a 2D array, or a 3D array.

Compared to irradiating a 1D array of regions of the substrate, irradiating a 2D array of regions of the substrate may provide an additional degree of freedom to select the sequence in which the regions of the substrate are irradiated. For example, compared to irradiating a 1D array of regions of the substrate, irradiating a 2D array of regions of the substrate may enable the use of even higher laser pulse repetition rates whilst still operating within the laser processing conditions window because consecutive laser pulses may be used to irradiate regions of the substrate which are separated by a greater distance and/or because nearest-neighbour regions of the substrate may be irradiated with non-consecutive laser pulses which are separated by a longer time period.

Compared to irradiating a 2D array of regions of the substrate, irradiating a 3D array of regions of the substrate may provide an additional degree of freedom to select the sequence in which the regions of the substrate are irradiated. For example, compared to irradiating a 2D array of regions of the substrate, irradiating a 3D array of regions of the substrate may enable the use of even higher laser pulse repetition rates whilst still operating within the laser processing conditions window because consecutive laser pulses may be used to irradiate regions of the substrate which are separated by a greater distance and/or because nearest-neighbour regions of the substrate may be irradiated with non-consecutive laser pulses which are separated by a longer time period.

The plurality of regions of the substrate may be arranged in a uniform array such as a uniform 1D array, a uniform 2D array, or a uniform 3D array.

The method may comprise irradiating the at least three regions of the substrate with the pulsed laser beam so as to modify the substrate according to a desired spatial profile.

The method may comprise irradiating the substrate with the pulsed laser beam so as to create or define one or more features or structures in the substrate. Each feature or structure may be configured to transmit, reflect, refract and/or diffract light. Each features or structure may comprise an optical device. Each features or structure may be configured to guide light. Each feature or structure may be configured to locate and/or align a separately formed optical component relative to the substrate. Each feature or structure may be configured to locate and/or align a separately formed optical waveguide or optical fibre relative to the substrate.

Optionally, the method comprises irradiating one or more of the regions of the at least three regions of the substrate with a corresponding single one of the laser pulses of the train of laser pulses.

Optionally, the method comprises irradiating one or more of the regions of the at least three regions of the substrate with a corresponding plurality of non-consecutive laser pulses of the train of laser pulses. Such a method may allow different regions of the at least three regions of the substrate to receive a different total dose of irradiation whilst still complying with the laser processing conditions window. This may be useful for varying the degree of modification between different regions of the substrate, for example for varying a refractive index modification between different regions of the substrate according to a desired refractive index profile.

Optionally, controlling the direction of the pulsed laser beam and/or the position of the substrate from laser pulse to laser pulse comprises controlling movement of the pulsed laser beam relative to the substrate from laser pulse to laser pulse, for example by steering the pulsed laser beam relative to the substrate from laser pulse to laser pulse.

Optionally, controlling the direction of the pulsed laser beam and/or the position of the substrate from laser pulse to laser pulse comprises controlling movement of the substrate relative to the pulsed laser beam. For example, the method may comprise controlling movement of the substrate relative to the pulsed laser beam in a direction parallel to a surface of the substrate. The method may comprise controlling movement of the substrate relative to the pulsed laser beam in a direction orthogonal to a surface of the substrate. The method may comprise controlling movement of the substrate in a direction of propagation of the pulsed laser beam. The method may comprise controlling movement of the substrate in a direction which is opposite to a direction of propagation of the pulsed laser beam. Such a method may allow the substrate to be modified in 3D.

Optionally, controlling the direction of the pulsed laser beam and/or the position of the substrate from laser pulse to laser pulse comprises controlling movement of the pulsed laser beam and/or the substrate so as to move the nominal writing position of the pulsed laser beam across the substrate with a velocity which varies during a time period over which the at least three consecutive laser pulses irradiate the at least three regions of the substrate.

Optionally, the velocity includes first and second velocity components.

Optionally, the first velocity component is constant and the second velocity component is variable.

Optionally, the first velocity component varies more slowly than the second velocity component.

Optionally, the first velocity component is unidirectional.

Optionally, the second velocity component varies in magnitude and/or in direction.

Optionally, the first velocity component is associated with movement of the substrate relative to the pulsed laser beam.

Optionally, the second velocity component is associated with movement of the pulsed laser beam relative to the substrate, for example wherein the second velocity component is associated with beam steering of the pulsed laser beam relative to the substrate.

The method may comprise using a beam scanner to control the direction of the pulsed laser beam from laser pulse to laser pulse so that the at least three consecutive laser pulses sequentially irradiate at least three regions of the substrate according to a predetermined spatial sequence which defines the relative spatial positions of the at least three regions of the substrate and the order of irradiation of the at least three regions of the substrate.

The method may comprise using a further beam scanner to impose an additional relative motion between the pulsed laser beam and the substrate onto the relative motion between the pulsed laser beam and the substrate provided by the beam scanner.

The beam scanner may have a response time that is faster than a response time of the further beam scanner.

The response time may refer to a time between the beam scanner (or further beam scanner) receiving an input signal that specifies a new configuration or state for the beam scanner (or further beam scanner) and the beam scanner (or further beam scanner) changing its configuration or state to match the new configuration or state.

The beam scanner may be configured to move, for example steer, the pulsed laser beam faster than the further beam scanner.

The further beam scanner may provide a greater associated range of movement of the pulsed laser beam than a range of movement of the pulsed laser beam that is associated with the beam scanner. The further beam scanner may be operable to steer the pulsed laser beam over a larger angular range than the beam scanner.

Using the beam scanner and the further beam scanner in combination in this way may enable the pulsed laser beam to be moved relative to the substrate over greater distances than using the beam scanner alone whilst also enabling irradiation of the at least three regions of the substrate according to a desired spatial profile at a higher laser pulse repetition rate than prior art methods without unduly damaging the substrate.

The beam scanner may comprise a non-mechanical beam scanner. The beam scanner may comprise a solid state beam scanner. The beam scanner may comprise an acousto-optic modulator beam scanner. The beam scanner may comprise an electro-optic modulator beam scanner.

The further beam scanner may comprise a mechanical beam scanner. The further beam scanner may include one or more moving parts. The further beam scanner may comprise a galvanometer beam scanner. The further beam scanner may comprise a tilting mirror beam scanner.

The method may comprise moving the substrate relative to the pulsed laser beam using a moveable stage such as a motion control stage or a translation stage to which the substrate is fixed. Using a moveable stage may enable larger areas of the substrate to be irradiated by the pulsed laser beam than would be possible by moving the pulsed laser beam relative to the substrate using the beam scanner and/or the further beam scanner.

The method may comprise moving the substrate relative to the pulsed laser beam whilst moving the pulsed laser beam relative to the substrate.

The method may comprise using the moveable stage to move the substrate relative to the pulsed laser beam whilst using the beam scanner and, optionally also the further beam scanner, to move the pulsed laser beam relative to the substrate.

The method may comprise generating a synchronisation control or trigger signal and using the synchronisation control or trigger signal to synchronise the relative movement between the substrate and the pulsed laser beam with the timing of the laser pulses of the train of laser pulses.

The method may comprise using a photodetector such as a high speed photodetector to detect a portion of the pulsed laser beam to thereby generate the synchronisation control signal.

The method may comprise using a pulse picker to control the timing of the laser pulses of the train of laser pulses according to the synchronisation control signal to synchronise the relative movement between the substrate and the pulsed laser beam with the timing of the laser pulses of the train of laser pulses.

The method may comprise using the synchronisation control signal to trigger or initiate the emission of each laser pulse of the train of laser pulses from a pulsed laser and using the synchronisation control signal to synchronise the relative movement between the substrate and the pulsed laser beam with the timing of the laser pulses of the train of laser pulses.

The method may comprise using the synchronisation control signal to trigger the generation of a predetermined waveform for controlling the sequence of irradiation of the at least three regions of the substrate with the pulsed laser beam. This may enable the positions of the irradiated regions of the substrate to be controlled more accurately.

The method may comprise using the synchronisation control signal to trigger an Arbitrary Waveform Generator to generate the predetermined waveform for controlling the sequence of irradiation of the at least three regions of the substrate with the pulsed laser beam.

The method may comprise determining or measuring emission timing data for one or more of the laser pulses. For example, the method may comprise detecting a portion of the pulsed laser beam to thereby measure the emission timing data for one or more of the laser pulses emitted from the pulsed laser.

The method may comprise determining or measuring a nominal writing position of the pulsed laser beam in the substrate. The method may comprise determining or measuring a velocity of the nominal writing position of the pulsed laser beam across the substrate. The method may comprise calculating a predicted nominal writing position of the pulsed laser beam in the substrate at a time of emission of a future laser pulse on the substrate using the measured emission timing data and at least one of the determined or measured nominal writing position of the pulsed laser beam in the substrate and the determined or measured velocity of the nominal writing position of the pulsed laser beam in the substrate. The method may comprise compensating for any difference between the predicted nominal writing position of the pulsed laser beam in the substrate and a corresponding desired nominal writing position of the pulsed laser beam in the substrate. For example, the method may comprise controlling a beam steering configuration of a beam scanner and/or a rate of change of the beam steering configuration of the beam scanner, to compensate for any difference between the predicted nominal writing position of the pulsed laser beam in the substrate and the desired nominal writing position of the pulsed laser beam in the substrate.

The method may comprise adjusting the timing of emission of a future laser pulse to compensate for any difference between the predicted nominal writing position of the pulsed laser beam in the substrate and the desired nominal writing position of the pulsed laser beam in the substrate.

Compensating for any difference between the predicted nominal writing position of the pulsed laser beam in the substrate and the desired nominal writing position of the pulsed laser beam in the substrate in this way may enable the plurality of regions of the substrate to be irradiated with a greater positional accuracy. This may improve the positional accuracy of any features created by modifying the substrate. This may minimise any unwanted spatial variation in the resulting modification of the substrate. For example, this may minimise any unwanted variation in the refractive index of the substrate. This may minimise any unwanted variation in the etchability of the substrate. This may minimise any unwanted surface roughness of the substrate following subsequent chemical etching of the substrate and/or where the substrate is modified by ablation of the material of the substrate.

The method may comprise determining or measuring a beam steering configuration such as one or more tilt angles of a slower beam scanner. The method may comprise using one or more sensors such as one or more rotary encoders to measure the beam steering configuration of the slower beam scanner. The method may comprise determining or measuring a rate of change of a beam steering configuration such as a rate of change of one or more tilt angles of the slower beam scanner. The method may comprise using one or more sensors such as one or more rotary encoders to measure the rate of change of the beam steering configuration of the slower beam scanner. The method may comprise calculating a predicted beam steering configuration of the slower beam scanner at a time of emission of a future laser pulse using the determined or measured emission timing data and at least one of the determined or measured beam steering configuration of the slower beam scanner and the determined or measured rate of change of the beam steering configuration of the slower beam scanner. The method may comprise using a faster beam scanner to compensate for any difference between the predicted beam steering configuration of the slower beam scanner and a desired beam steering configuration of the slower beam scanner at the time of emission of the future laser pulse. For example, the method may comprise controlling a beam steering configuration of the faster beam scanner and/or a rate of change of the beam steering configuration of the faster beam scanner to compensate for any difference between the predicted beam steering configuration of the slower beam scanner at the time of emission of the future laser pulse and a desired beam steering configuration of the slower beam scanner at the time of emission of the future laser pulse.

Using the faster beam scanner in this way to compensate for any difference between the beam steering configuration of the slower beam scanner and the desired beam steering configuration of the slower beam scanner at the time of emission of the future laser pulse may enable each of the regions of the substrate to be irradiated with a greater positional accuracy. This may improve the positional accuracy of any features created by modifying the substrate. This may minimise any unwanted spatial variation in the resulting modification of the substrate. For example, this may minimise any unwanted variation in the refractive index of the substrate. This may minimise any unwanted variation in the etchability of the substrate. This may minimise any unwanted surface roughness of the substrate following subsequent chemical etching of the substrate and/or where the substrate is modified by ablation of the material of the substrate. When the speed of the slower beam scanner is increased, the differences between the measured beam steering configuration of the slower beam scanner and the desired future beam steering configuration of the slower beam scanner may increase. Accordingly, using the faster beam scanner in this way to compensate for any difference between the predicted beam steering configuration of the slower beam scanner and the desired future beam steering configuration of the slower beam scanner may mean that the slower beam scanner can be operated at higher speeds without unduly degrading the positional accuracy with which the pulsed laser beam can irradiate each of the regions of the substrate thereby increasing the overall laser processing throughput.

The train of laser pulses may be periodic.

The train of laser pulses may have a repetition rate of at least 100 KHz, of at least 1 MHz, of at least 2 MHz, of at least 5 MHz or of at least 10 MHz.

The train of laser pulses may be generated using a Q-switched laser or a mode-locked laser.

The train of laser pulses may be generated using a laser in combination with an optical modulator.

According to an aspect of the present disclosure, there is provided an apparatus for modifying a substrate, the apparatus comprising:
a pulsed laser for generating a pulsed laser beam comprising a train of laser pulses including at least three consecutive laser pulses; and
an irradiation control arrangement for controlling a direction of the pulsed laser beam and/or a position of the substrate from laser pulse to laser pulse so that the at least three consecutive laser pulses sequentially irradiate at least three regions of the substrate according to a predetermined spatial sequence which defines the relative spatial positions, and the order of irradiation, of the at least three regions of the substrate.

Optionally, the at least three regions of the substrate are different, distinct and/or non-overlapping regions of the substrate.

The irradiation control arrangement may be configured to control the direction of the pulsed laser beam and/or the position of the substrate from laser pulse to laser pulse so that the at least three consecutive laser pulses sequentially irradiate at least three regions of the substrate according to the predetermined spatial sequence by synchronising a movement of the pulsed laser beam and/or of the substrate with the timing of the at least three consecutive laser pulses so that the at least three regions of the substrate are sequentially irradiated with the at least three consecutive laser pulses according to the predetermined spatial sequence.

The irradiation control arrangement may be configured to control the direction of the pulsed laser beam and/or the position of the substrate from laser pulse to laser pulse so that the at least three consecutive laser pulses sequentially irradiate at least three regions of the substrate according to the predetermined spatial sequence by:
controlling movement of the pulsed laser beam and/or of the substrate so as to move a nominal writing position of the pulsed laser beam to a first position in the substrate so that a first one of the at least three consecutive laser pulses irradiates a first region of the substrate centred on the first position;
controlling movement of the pulsed laser beam and/or of the substrate so as to move the nominal writing position of the pulsed laser beam across the substrate along a first direction from the first position in the substrate to a second position in the substrate so that a second one of the at least three consecutive laser pulses irradiates a second region of the substrate centred on the second position; and
controlling movement of the pulsed laser beam and/or of the substrate so as to move the nominal writing position of the pulsed laser beam across the substrate along a second direction from the second position in the substrate to a third position in the substrate so that a third one of the at least three consecutive laser pulses irradiates a third region of the substrate centred on the third position,
wherein the first and second directions are different.

Optionally, the first, second and third regions of the substrate are different, distinct and/or non-overlapping regions of the substrate.

Optionally, the first, second and third positions in the substrate are different positions in the substrate.

The third region of the substrate may be located closer to the first region than the second region.

The irradiation control arrangement may comprise a beam scanner for controlling a nominal writing position of the pulsed laser beam in the substrate. The beam scanner may comprise a non-mechanical beam scanner. The beam scanner may comprise a solid state beam scanner. The beam scanner may comprise an acousto-optic modulator beam scanner. The beam scanner may comprise an electro-optic modulator beam scanner.

The irradiation control arrangement may comprise a further beam scanner for controlling the nominal writing position of the pulsed laser beam in the substrate.

The further beam scanner may comprise a mechanical beam scanner. The further beam scanner may include one or more moving parts. The further beam scanner may comprise a galvanometer beam scanner. The further beam scanner may comprise a tilting mirror beam scanner.

The beam scanner may be configured to rotate a direction of the pulsed laser beam around one axis.

The beam scanner may be configured to rotate a direction of the pulsed laser beam around two non-parallel axes, for example two orthogonal axes.

The beam scanner may comprise a first beam scanner element for varying an angle of the pulsed laser beam around a corresponding first axis and a second beam scanner element for varying an angle of the pulsed laser beam around a corresponding second axis, wherein the first and second axes are non-parallel, for example orthogonal. The beam scanner may comprise a first lens and a second lens. The first and second lenses may be arranged in a 4f configuration, wherein the first and second lenses are separated by a distance of 2f, the first beam scanner element is located in a back focal plane of the first lens, and the second beam scanner element is located in a front focal plane of the second lens. Alternatively, the beam scanner may comprise a half-pitch GRIN rod lens. The first beam scanner element may be located at a first end of the half-pitch GRIN rod lens and the second beam scanner element may be located at a second end of the half-pitch GRIN rod lens. Such a beam scanner comprising a half-pitch GRIN rod lens may serve to reduce a variation in the optical path length experienced by the pulsed laser beam as the direction of the pulsed laser beam is scanned by the first beam scanner element when compared with a beam scanner comprising first and second lenses in a 4f configuration. Such a beam scanner comprising a half-pitch GRIN rod lens may also have improved robustness and/or be easier to align optically when compared with a beam scanner comprising first and second lenses in a 4f configuration.

One or each of the first and second beam scanner elements may comprise a non-mechanical beam scanner element. One or each of the first and second beam scanner elements may comprise a solid state beam scanner element. One or each of the first and second beam scanner elements may comprise an acousto-optic modulator beam scanner element. One or each of the first and second beam scanner elements may comprise an electro-optic modulator beam scanner element.

The further beam scanner may be configured to rotate a direction of the pulsed laser beam around one axis.

The further beam scanner may be configured to rotate a direction of the pulsed laser beam around two non-parallel axes, for example two orthogonal axes.

The irradiation control arrangement may comprise a third lens and a fourth lens. The beam scanner, the third and fourth lenses, and the further beam scanner may be arranged in a 4f configuration, wherein the third and fourth lenses are separated by a distance of 2f, the beam scanner is located in a back focal plane of the third lens, and the further beam scanner is located in a front focal plane of the fourth lens.

The irradiation control arrangement may comprise a fifth lens, a sixth lens and a microscope objective. The further beam scanner, the fifth and sixth lenses, and the microscope objective may be arranged in a 4f configuration, wherein the fifth and sixth lenses are separated by a distance of 2f, the further beam scanner is located in a back focal plane of the fifth lens, and the microscope objective is located in a front focal plane of the sixth lens.

The irradiation control arrangement may comprise a moveable stage for moving the substrate relative to the pulsed laser beam. The moveable stage may comprise a motion control stage or a translation stage to which the substrate is fixed.

The apparatus may be configured to generate a synchronisation control signal and to use the synchronisation control signal to synchronise relative movement between the substrate and the pulsed laser beam with the timing of the laser pulses of the train of laser pulses.

The apparatus may comprise a detector such as a high speed photodetector for detecting a portion of the pulsed laser beam to thereby generate the synchronisation control signal.

The irradiation control arrangement may be configured to use the synchronisation control signal to generate a predetermined sequence for irradiating of the at least three regions of the substrate with the pulsed laser beam.

The irradiation control arrangement may comprise an Arbitrary Waveform Generator that is configured to use the synchronisation control signal to generate a predetermined waveform for controlling the sequence of irradiation of the at least three regions of the substrate with the pulsed laser beam.

It should be understood that any one or more of the features of any one of the foregoing aspects of the present disclosure may be combined with any one or more of the features of any of the other foregoing aspects of the present disclosure.

### BRIEF DESCRIPTION OF THE DRAWINGS

These and other aspects of the present disclosure will now be described, by way of non-limiting example only, with reference to the accompanying drawings, wherein:

FIG. 1 depicts a schematic diagram of an apparatus for modifying a substrate;

FIG. 2 depicts a flow chart detailing a method of modifying a substrate;

FIG. 3 depicts first, second, third, and fourth pulse spatial sequences for use in modifying a substrate in 1D using the method of FIG. 2;

FIG. 4A depicts a graph showing a position of a region of the substrate irradiated by each laser pulse as a function of time for laser pulses according to the first pulse spatial sequence of FIG. 3;

FIG. 4B depicts a graph showing a contribution of a faster beam scanner to the graph of FIG. 4A isolated from a contribution of a slower further beam scanner;

FIG. 5A depicts a graph showing a position of a region of the substrate irradiated by each laser pulse as a function of time for laser pulses according to the second pulse spatial sequence of FIG. 3;

FIG. 5B depicts a graph showing a contribution of the faster beam scanner to the graph of FIG. 5A isolated from a contribution of the slower further beam scanner;

FIG. 6A depicts a graph showing a position of a region of the substrate irradiated by each laser pulse as a function of time for laser pulses according to the third pulse spatial sequence of FIG. 3;

FIG. 6B depicts a graph showing a contribution of the faster beam scanner to the graph of FIG. 6A isolated from a contribution of the slower further beam scanner;

FIG. 7A depicts a graph showing a position of a region of the substrate irradiated by each laser pulse as a function of time for laser pulses according to the fourth pulse spatial sequence of FIG. 3;

FIG. 7B depicts a graph showing a contribution of the faster beam scanner to the graph of FIG. 7A isolated from a contribution of the slower further beam scanner;

FIG. 8 depicts a first pulse spatial sequence for use in modifying a substrate in 2D using the method of FIG. 2 showing a 2D position of a region of the substrate irradiated by each laser pulse;

FIG. 9 depicts a second pulse spatial sequence for use in modifying a substrate in 2D using the method of FIG. 2 showing a 2D position of a region of the substrate irradiated by each laser pulse;

FIG. 10 depicts a third pulse spatial sequence for use in modifying a substrate in 2D using the method of FIG. 2 showing a 2D position of a region of the substrate irradiated by each laser pulse;

FIG. 11 depicts a fourth pulse spatial sequence for use in modifying a substrate in 2D using the method of FIG. 2 showing a 2D position of a region of the substrate irradiated by each laser pulse;

FIG. 12 depicts a fifth pulse spatial sequence for use in modifying a substrate in 2D using the method of FIG. 2 showing a 2D position of a region of the substrate irradiated by each laser pulse; and

FIG. 13 depicts a schematic diagram of an alternative two-axis beam scanner for use in the apparatus of FIG. 1.

### DETAILED DESCRIPTION OF THE DRAWINGS

FIG. 1 depicts a schematic diagram of an apparatus 100 for modifying a substrate 108. The apparatus 100 includes a pulsed laser 102 and an irradiation control arrangement 103.

The pulsed laser 102 is a pulsed femtosecond laser for emitting a pulsed laser beam 150 in the form of a train of laser pulses with a wavelength in the region of 1035 nm, a repetition rate in the range 100 KHz-10 MHz, and a pulse energy in the range of 100 to 2000 nJ.

The irradiation control arrangement 103 includes a beam steering arrangement 104 and a moveable stage 109. The substrate 108 is fixed to the moveable stage 109.

The beam steering arrangement 104 includes a two-axis beam scanner in the form of a two-axis acousto-optic modulator (AOM) beam scanner 120, an optical relay system 126, a further two-axis beam scanner in the form of a two-axis galvanometer beam scanner 122, a further optical relay system 144 and a microscope objective 148.

The two-axis AOM beam scanner 120 includes a first one-axis beam scanner element in the form of a first one-axis acousto-optic modulator (AOM) beam scanner element 130 and a second one-axis beam scanner element in the form of a second one-axis AOM beam scanner element 134. The beam scanner 120 further includes a first lens 132 and a second lens 133. The first beam scanner element 132, the first lens 132, the second lens 133, and the second beam scanner element 134 are arranged in a 4f configuration, wherein the first and second lenses 132, 133 are separated by a distance of 2f, the first beam scanner element 130 is located in a back focal plane of the first lens 132, and the second beam scanner element 134 is located in a front focal plane of the second lens 133.

To achieve 2D beam steering, the first and second beam scanner elements 130, 134 are arranged to be mutually orthogonal. Specifically, the first beam scanner element 130 is configured to control a direction of the pulsed laser beam 150 by rotating the pulsed laser beam 150 around the y axis and the second beam scanner element 134 is configured to control a direction of the pulsed laser beam 150 by rotating the pulsed laser beam 150 around the x axis.

The optical relay system 126 comprises a third lens 136 and a fourth lens 137. The second beam scanner element 134, the third lens 136, the fourth lens 137, and the further beam scanner 122 are arranged in a 4f configuration. Specifically, the third and fourth lenses 136, 137 are separated by a distance of 2f, the second beam scanner element 136 of the beam scanner 120 is located in a back focal plane of the third lens 136, and the galvanometer beam scanner 122 is located in a front focal plane of the fourth lens 137.

The further optical relay system 144 includes a fifth lens in the form of a scan lens 140 and a sixth lens in the form of a tube lens 142. The galvanometer beam scanner 122, the fifth lens 140, the sixth lens 142, and the microscope objective 148 are arranged in a 4f configuration, wherein the fifth and sixth lenses 140, 142 are separated by a distance of 2f, the galvanometer beam scanner 122 is located in a back focal plane of the fifth lens 140, and the microscope objective 148 is located in a front focal plane of the sixth lens 142.

The irradiation control arrangement 103 further includes a photodetector in the form of a high speed photodetector 110, a beamsplitter 111 for diverting a portion of the pulsed laser beam 150 to the high speed photodetector 110, and a signal generator in the form of an Arbitrary Waveform Generator (AWG) 112, and a controller 114. The galvanometer scanner 122 also includes one or more sensors in the form of one or more rotary encoders 123 for measuring a beam steering configuration of the galvanometer beam scanner 122.

As indicated by the dashed lines in FIG. 1, the controller 114 is configured for communication with the photodetector 110, the AWG 112, and the one or more rotary encoders 123 of the galvanometer beam scanner 122. Furthermore, the AWG 112 is connected electrically to the first and second beam scanner elements 130, 134 of the AOM beam scanner 120.

As will be described in more detail below, the Arbitrary Waveform Generator 112 is configured to generate a waveform or signal which is used to control the first and second beam scanner elements 130, 134 of the AOM beam scanner 120 so as to steer the pulsed laser beam 150 emitted by the pulsed laser 102 according to a beam-steering spatial sequence to thereby control a direction of the pulsed laser beam 150 from laser pulse to laser pulse so that at least three consecutive laser pulses sequentially irradiate at least three regions of the substrate 108 according to a predetermined spatial sequence which defines the relative spatial positions of the at least three regions of the substrate 108 and the order of irradiation of the at least three regions of the substrate 108.

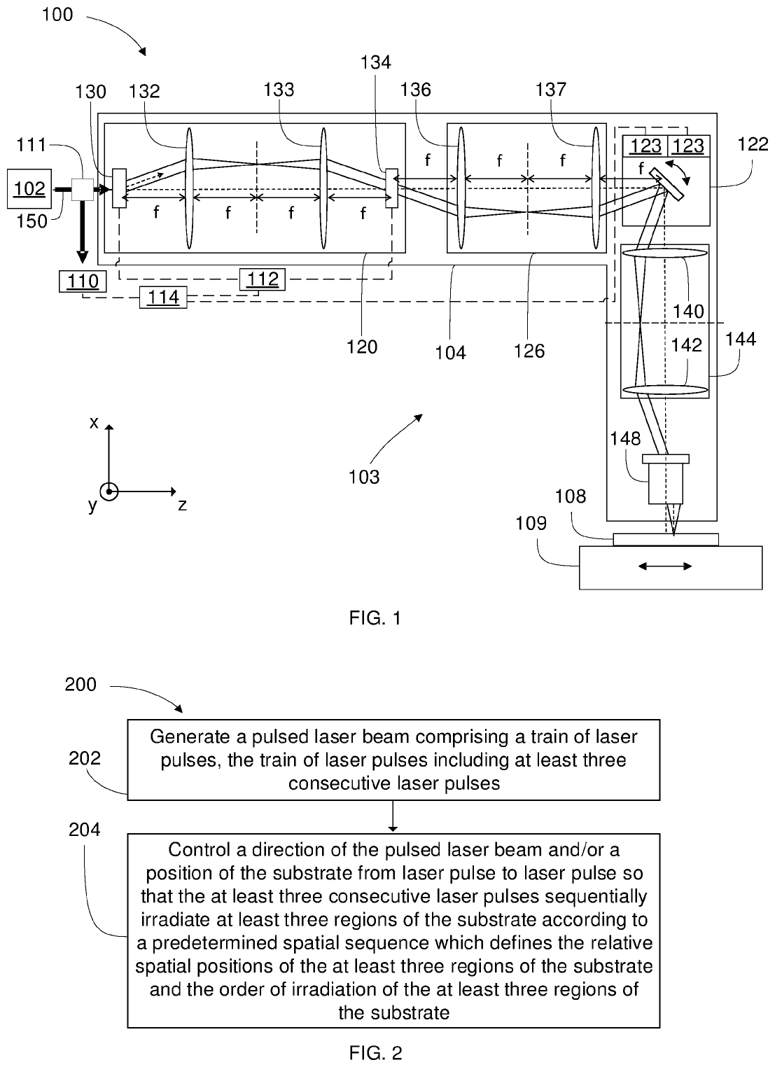

In use, the apparatus 100 modifies the substrate 108 according to a method 200 depicted in FIG. 2. The substrate 108 comprises at least three regions. The method 200 begins at step 202 with the pulsed laser 102 generating a pulsed laser beam 150 comprising a train of laser pulses including at least three consecutive laser pulses. The method 200 continues at step 204 with the irradiation control arrangement 103 controlling irradiation of the substrate 108 with the pulsed laser beam 150 so as to modify the substrate 108. Specifically, the irradiation control arrangement 103 controls a direction of the pulsed laser beam 150 and/or a position of the substrate from laser pulse to laser pulse so that at least three consecutive laser pulses sequentially irradiate at least three regions of the substrate 108 according to a predetermined spatial sequence which defines the relative spatial positions of the at least three regions of the substrate 108 and the order of irradiation of the at least three regions of the substrate 108.

In more detail, following emission from the laser 102, the pulsed laser beam 150 is received by the two-axis AOM beam scanner 120. The first beam scanner element 130 of the two-axis AOM beam scanner 120 controls a direction of the pulsed laser beam 150 in 1D by rotating the pulsed laser beam 150 around the y axis and the second beam scanner element 134 of the two-axis AOM beam scanner 120 controls a direction of the pulsed laser beam 150 in 1D by rotating the pulsed laser beam 150 around the x axis.

The optical relay system 126 couples the pulsed laser beam 150 from the second beam scanner element 134 of the two-axis AOM beam scanner 120 to the galvanometer beam scanner 122.

The galvanometer beam scanner 122 provides additional steering of the pulsed laser beam 150 in two dimensions (i.e. around both the x-axis and the y-axis).

The further optical relay system 144 couples the pulsed laser beam 150 to the microscope objective 148. The microscope objective 148 focuses the pulsed laser beam 150 onto the substrate.

Using the AOM beam scanner 120 and the galvanometer beam scanner 122, the irradiation control arrangement 103 moves the pulsed laser beam 150 relative to the substrate 108 by steering the pulsed laser beam 150 in two dimensions in a plane parallel to an upper surface of the substrate 108. Specifically, the AOM beam scanner 120 steers the pulsed laser beam 150 so as to irradiate the first region with the first laser pulse, irradiate the third region with the second laser pulse, and then irradiate the second region with the third laser pulse. The galvanometer beam scanner 122 imposes additional motion on the pulsed laser beam 150 relative to the substrate 108, wherein the additional motion is additional to the motion of the pulsed laser beam 150 relative to the substrate 108 that is imposed by the AOM beam scanner 120. For example, the galvanometer beam scanner 122 imposes an additional linear motion on the pulsed laser beam 150 relative to the substrate 108.

The AOM beam scanner 120 steers the pulsed laser beam 150 faster than the galvanometer beam scanner 122 and/or has a response time that is faster than a response time of the galvanometer beam scanner 122. Consequently, using the AOM beam scanner 120 and the galvanometer beam scanner 122 in combination enables the pulsed laser beam 150 to be steered faster than would be possible using the galvanometer beam scanner 122 alone and over a larger area of the substrate 108 than would be possible using the AOM beam scanner 120 alone. Furthermore, using the moveable stage 109 to move the substrate 108 relative to the pulsed laser beam 150 enables even larger areas of the substrate 108 to be irradiated.

The beamsplitter 111 diverts a portion of the pulsed laser beam 150 onto the photodetector 110 causing the photodetector 110 to generate a synchronisation control signal containing timing information of each pulse within the pulsed laser beam 150. The synchronisation control signal is transmitted electrically to the controller 114. The controller 114 uses the synchronisation control signal to trigger the AWG 112. When triggered by the synchronisation control signal, the AWG 112, generates waveforms which are used to control the first and second AOM beam scanner elements 130, 132 of the AOM beam scanner 120 so as to control the movement of the pulsed laser beam 150 relative to the substrate 108 according to a desired pulse spatial sequence.

Furthermore, the one or more rotary encoders 123 generate signals representative of a beam steering configuration of the galvanometer beam scanner 122 and/or a rate of change of a beam steering configuration of the galvanometer beam scanner 122. Specifically, the one or more rotary encoders 123 generate signals representative of one or more tilt angles of the mirrors of the galvanometer beam scanner 122 and/or a rate of change of one or more tilt angles of the mirrors of the galvanometer beam scanner 122. The signals representative of the beam steering configuration of the galvanometer beam scanner 122 and/or the rate of change of the beam steering configuration of the galvanometer beam scanner 122 are transmitted electrically from the one or more rotary encoders 123 to the controller 114. The controller 114 then uses the synchronisation control signal and the signals representative of the beam steering configuration of the galvanometer beam scanner 122 and/or the rate of change of the beam steering configuration of the galvanometer beam scanner 122 to predict a beam steering configuration of the galvanometer beam scanner 122 at a time of emission of a future laser pulse and the controller 114 controls the beam steering configuration and/or the rate of change of the beam steering configuration of the faster AOM beam scanner 120 so as to compensate for any difference between the predicted beam steering configuration of the galvanometer beam scanner 122 and a desired future beam steering configuration of the galvanometer beam scanner 122 at the time of emission of the future laser pulse.

Using the faster AOM beam scanner 120 in this way to compensate for any difference between the predicted beam steering configuration of the slower galvanometer beam scanner 122 and the desired future beam steering configuration of the slower galvanometer beam scanner 122 at the time of emission of the future laser pulse may enable each region of the substrate 108 to be irradiated with a greater positional accuracy. This may improve the positional accuracy of any features created by modifying the substrate 108. This may minimise any unwanted spatial variation in the resulting modification of the substrate 108. For example, this may minimise any unwanted variation in the refractive index of the substrate 108. This may minimise any unwanted variation in the etchability of the substrate 108. This may minimise any unwanted surface roughness of the substrate 108 following subsequent chemical etching of the substrate 108 and/or where the substrate 108 is modified by ablation of the material of the substrate 108. When the speed of the slower galvanometer beam scanner 122 is increased, the differences between the measured beam steering configuration of the slower galvanometer beam scanner 122 and the intended beam steering configuration of the slower galvanometer beam scanner 122 may increase. Accordingly, using the faster AOM beam scanner 120 in this way to compensate for any difference between the beam steering configuration of the slower galvanometer beam scanner 122 and the intended beam steering configuration of the slower galvanometer beam scanner 122 may also mean that the slower galvanometer beam scanner 122 can be operated at higher speeds without unduly degrading the positional accuracy with which the pulsed laser beam 150 can irradiate each of the regions of the substrate 108 thereby increasing the overall laser processing throughput.

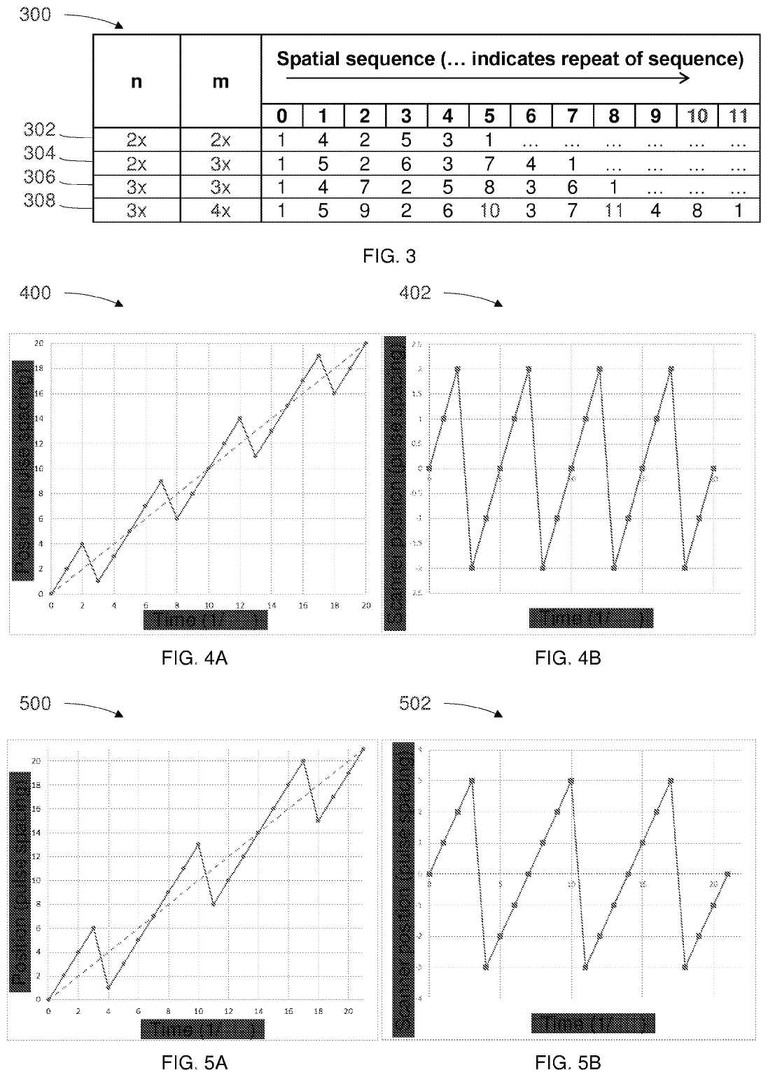

FIG. 3 lists examples 300 of a first linear pulse spatial sequence 302, a second linear pulse spatial sequence 304, a third linear pulse spatial sequence 306, and a fourth linear pulse spatial sequence 308. In FIG. 3, different regions of the substrate 108 are arranged in a 1D uniform array along a linear path and are labelled “0” to “11”. Each of the linear pulse spatial sequences 302, 304, 306, 308 specifies the sequence or order in which each different region “0” to “11” of the substrate 108 is irradiated with a corresponding laser pulse.

As will be described in more detail below, each linear pulse spatial sequence 302, 304, 306, 308 involves “jumping” the pulsed laser beam 150 ahead along the linear path and then “jumping” the pulsed laser beam 150 back along the linear path, such that consecutive laser pulses irradiate non-adjacent regions of the substrate 108. Consequently, adjacent regions of the substrate 108 are irradiated with non-consecutive laser pulses.

Each linear pulse spatial sequence has a period defined as a number of laser pulses in the sequence before the sequence repeats. Furthermore, each linear pulse spatial sequence is characterized by two parameters. The first parameter is a minimum spatial jump n between consecutive pulses (in units of pulse spacing). The second parameter is a minimum temporal period m between adjacent irradiated regions of the substrate 108—in units of 1/RR, wherein RR is the repetition rate of the laser pulses in the pulsed laser beam 150. To increase m or n, the period of the linear spatial sequence must be increased.

For example, the first linear pulse spatial sequence 302 (n=2, m=2) has a period of 5 before the sequence repeats, the second linear pulse spatial sequence 304 (n=2, m=3) has a period of 7 before the sequence repeats, the third linear pulse spatial sequence 306 (n=3, m=3) has a period of 8 before the sequence repeats, the fourth linear pulse spatial sequence 308 (n=3, m=4) has a period of 11 before the sequence repeats.

FIG. 4A depicts a graph 400 showing a position of a region of the substrate 108 irradiated by each laser pulse as a function of time according to the first linear pulse spatial sequence 302. The graph 400 corresponds to using the irradiation control arrangement 103 to steer the pulsed laser beam 150 so as to irradiate different regions of the substrate 108 with different laser pulses along a linear path according to the first linear pulse spatial sequence 302. As a function of time, the positions of the irradiated regions follow a saw-tooth pattern that is attributable to the beam-steering of the faster AOM beam scanner 120 superimposed upon a positive linear ramp depicted by the dashed line, wherein the positive linear ramp is attributable to a constant beam-steering speed of the slower galvanometer beam scanner 122 e.g. to a linear rate of change of a beam-steering angle attributable to the operation of the slower galvanometer scanner 122.

More specifically, according to the first linear pulse spatial sequence 302, a first pulse in the sequence is incident on region 0, a second pulse in the sequence is incident on region 2 (i.e. jumping ahead past region 1), a third pulse in the sequence is incident on region 4 (i.e. jumping ahead past region 3), a fourth pulse in the sequence is incident on region 1 (i.e. jumping back to region 1), and a fifth pulse in the sequence is incident on region 3 (i.e. jumping ahead past region 2). After this, the sequence repeats. However, because the galvanometer beam scanner 122 imposes the constant rate of movement of the pulsed laser beam 150 relative to the substrate 108 depicted by the dashed line, the sixth pulse in the sequence (i.e. which is the first pulse of a new sequence), is incident on region 5 (i.e. instead of region 0 as would be the case without the constant rate of movement of the pulsed laser beam 150 relative to the substrate 108). Accordingly, the first linear pulse spatial sequence 302 defines the irradiation of different regions of the substrate 108, without consecutive laser pulses being used to irradiate regions of the substrate 108 that are adjacent to each other.

FIG. 4B depicts a graph 402 showing a contribution of the AOM beam scanner 120 to the graph 400 of FIG. 4A isolated from a contribution of the galvanometer beam scanner 122. Because the graph 402 does not include the contribution of the galvanometer beam scanner 122, the constant speed of movement of the pulsed laser beam 150 relative to the substrate 108, which is attributable to the operation of the slower galvanometer beam scanner 122, is not shown in FIG. 4B. Accordingly, the graph 402 depicts a periodic saw-tooth pattern, which repeats with every iteration of the sequence. As may be appreciated from FIG. 4B, the periodic saw-tooth pattern comprises a plurality of teeth, wherein each tooth includes a more gradual positively sloped portion defined by a plurality of positions having values which increase progressively with time followed by a steeper negatively sloped portion.

FIG. 5A depicts a graph 500 showing a position of a region of the substrate 108 irradiated by each laser pulse as a function of time for laser pulses according to the second linear pulse spatial sequence 304 of FIG. 3. FIG. 5B depicts a graph 502 showing a contribution of the AOM beam scanner 120 to the graph 500 of FIG. 5A isolated from a contribution of the galvanometer beam scanner 122.

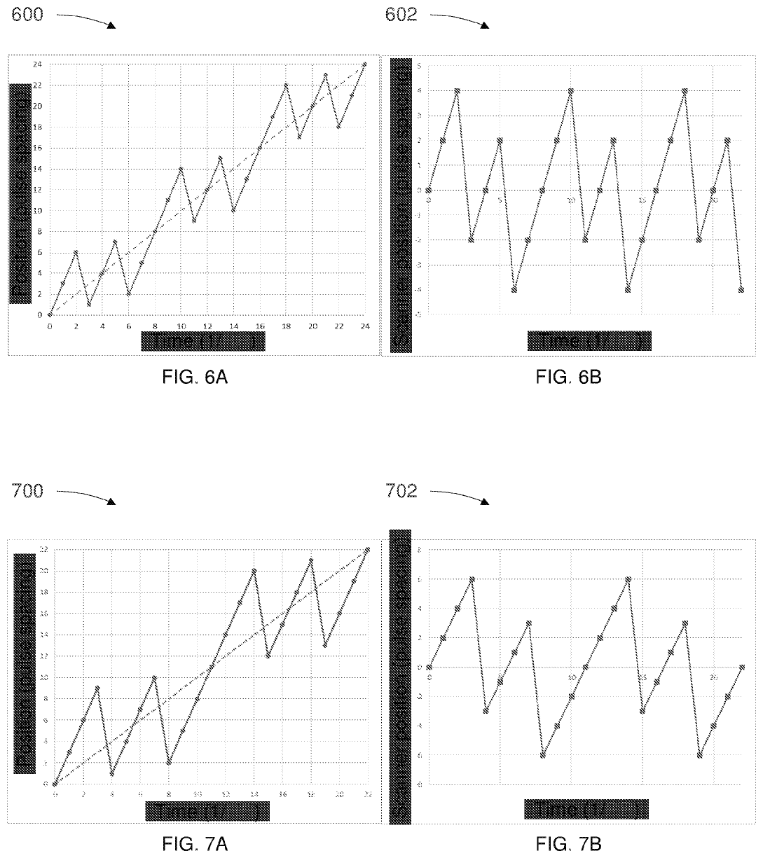

FIG. 6A depicts a graph 600 showing a position of a region of the substrate 108 irradiated by each laser pulse as a function of time for laser pulses according to the third linear pulse spatial sequence 306 of FIG. 3. FIG. 6B depicts a graph 602 showing a contribution of the AOM beam scanner 120 to the graph 600 of FIG. 6A isolated from a contribution of the galvanometer beam scanner 122.

FIG. 7A depicts a graph 700 showing a position of a region of the substrate 108 irradiated by each laser pulse as a function of time for laser pulses according to the fourth linear pulse spatial sequence 308 of FIG. 3. FIG. 7B depicts a graph 702 showing a contribution of the AOM beam scanner 120 to the graph 700 of FIG. 7A isolated from a contribution of the galvanometer beam scanner 122.

As may be appreciated from the foregoing description of FIGS. 4A-7B, the linear pulse spatial sequences of FIG. 3 enable the use of an increased repetition rate of laser pulses and a corresponding increase in the speed of the additional scanning provided by the galvanometer beam scanner 122 along the linear path, without causing significant changes to the form of induced modification of the substrate 108. Consequently, the method 200 described above for modifying the substrate 108 increases the laser processing throughput of the substrate 108.

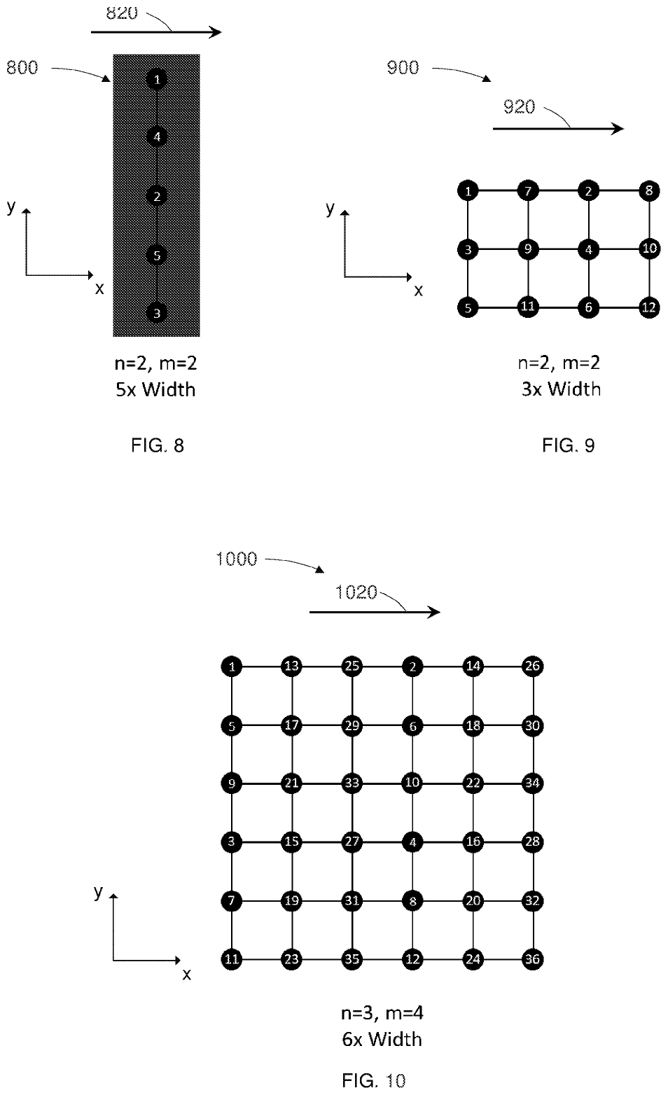

FIG. 8 depicts a first pulse spatial sequence 800 for use in the method 200 of FIG. 2 showing a 2D position of a region of the substrate irradiated by each laser pulse of a sequence of five laser pulses. Specifically, the first pulse spatial sequence 800 defines the order of irradiation of five distinct regions of the substrate 108 using the five laser pulses, wherein the five distinct regions are arranged along a y direction by using the AOM beam scanner 120 to steer the pulsed laser beam 150 in the y direction and the galvanometer beam scanner 122 to steer the pulsed laser beam 150 in the x direction as indicated by the arrow 820. The positions of the irradiated regions of the substrate 108 of the first pulse spatial sequence 800 are arranged in a uniform linear array with a width (i.e. along the y direction) of five times the spacing between the adjacent regions. For the first pulse spatial sequence 800, n=2 and m=2.

FIG. 9 depicts a second pulse spatial sequence 900 for use in the method 200 of FIG. 2 showing a 2D position of a region of the substrate 108 irradiated by each laser pulse of a sequence of 12 laser pulses. Specifically, the second pulse spatial sequence 900 defines the order of irradiation of 12 distinct regions of the substrate 108 using the 12 laser pulses, wherein the 12 distinct regions are arranged in 2D by using the AOM beam scanner 120 to steer the pulsed laser beam 150 in 2D and the galvanometer beam scanner 122 to steer the pulsed laser beam 150 in the x direction as indicated by the arrow 920. The second pulse spatial sequence 900 has a width (i.e. along the y direction) of 3 times the spacing between the adjacent regions. The second pulse spatial sequence 900 has a length (i.e. along the x direction) of 4 times the spacing between the adjacent regions. For the second pulse spatial sequence 900, n=2 and m=2.

FIG. 10 depicts a third pulse spatial sequence 1000 for use in the method 200 of FIG. 2 showing a 2D position of a region of the substrate 108 irradiated by each laser pulse of a sequence of 36 laser pulses. Specifically, the third pulse spatial sequence 1000 defines the order of irradiation of 36 distinct regions of the substrate 108 using the 36 laser pulses, wherein the 36 distinct regions are arranged in 2D by using the AOM beam scanner 120 to steer the pulsed laser beam 150 in 2D and the galvanometer beam scanner 122 to steer the pulsed laser beam 150 in the x direction as indicated by the arrow 1020. The third pulse spatial sequence 1000 has a width (i.e. along the y direction) of 6 times the spacing between the adjacent regions. The third pulse spatial sequence 1000 has a length (i.e. along the x direction) of 6 times the spacing between the adjacent regions. For the third pulse spatial sequence 1000, n=3 and m=4.

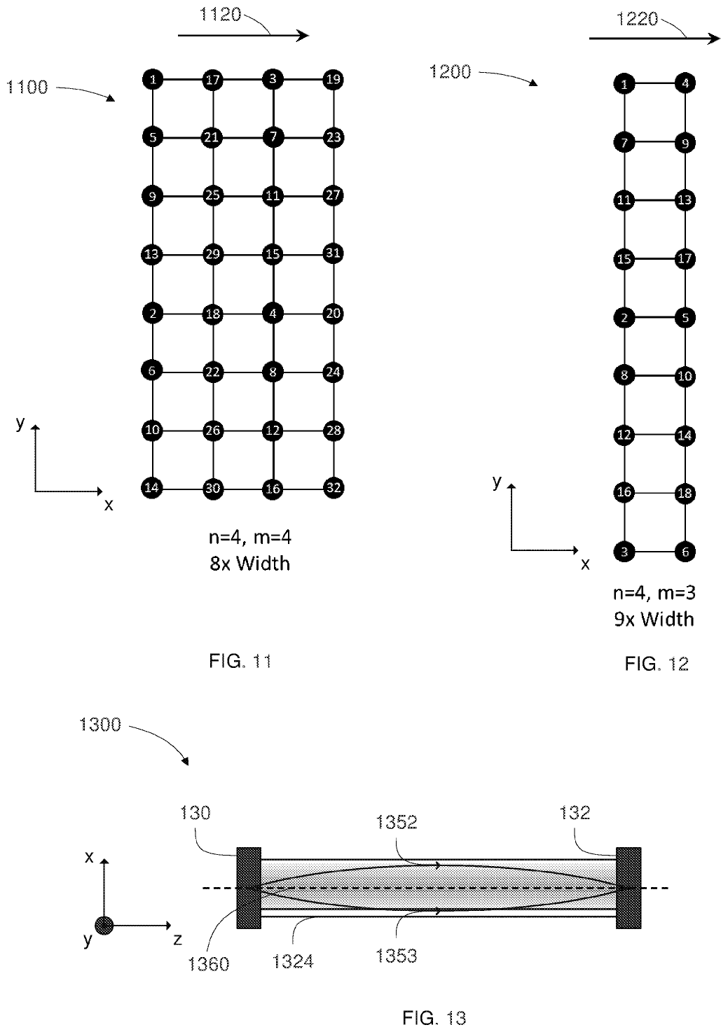

FIG. 11 depicts a fourth pulse spatial sequence 1100 for use in the method 200 of FIG. 2 showing a 2D position of a region of the substrate 108 irradiated by each laser pulse of a sequence of 32 laser pulses. Specifically, the fourth pulse spatial sequence 1100 defines the order of irradiation of 32 distinct regions of the substrate 108 using the 32 laser pulses, wherein the 32 distinct regions are arranged in 2D by using the AOM beam scanner 120 to steer the pulsed laser beam 150 in 2D and the galvanometer beam scanner 122 to steer the pulsed laser beam 150 in the x direction as indicated by the arrow 1120. The fourth pulse spatial sequence 1100 has a width (i.e. along the y direction) of 8 times the spacing between the adjacent regions. The fourth pulse spatial sequence 1100 has a length (i.e. along the x direction) of 4 times the spacing between the adjacent regions. For the fourth pulse spatial sequence 1100, n=4 and m=4.

FIG. 12 depicts a fifth pulse spatial sequence 1200 for use in the method 200 of FIG. 2 showing a 2D position of a region of the substrate 109 irradiated by each laser pulse of a sequence of 18 laser pulses. Specifically, the fifth pulse spatial sequence 1200 defines the order of irradiation of 18 distinct regions of the substrate 108 using the 18 laser pulses, wherein the 18 distinct regions are arranged in 2D by using the AOM beam scanner 120 to steer the pulsed laser beam 150 in 2D and the galvanometer beam scanner 122 to steer the pulsed laser beam 150 in the x direction as indicated by the arrow 1220. The fifth pulse spatial sequence 1200 has a width (i.e. along the y direction) of 9 times the spacing between the adjacent regions. The fifth pulse spatial sequence 1200 has a length (i.e. along the x direction) of 2 times the spacing between the adjacent regions. For the fifth pulse spatial sequence 1200, n=4 and m=3.

As may be appreciated from the description of the spatial sequences depicted in FIGS. 8 to 12, using the AOM beam scanner 120 and the galvanometer beam scanner 122 in combination to irradiate the substrate 108 according to the pulse spatial sequences 800, 900, 1000, 1100, 1200 results in a substrate laser processing speed that is higher than could be achieved using the galvanometer beam scanner 122 alone and may result in a higher laser processing throughput of the substrate 108 compared with prior art methods for laser processing a substrate.

Referring now to FIG. 13, there is shown a schematic diagram of an alternative two-axis AOM beam scanner 1300 for use in the apparatus 100 of FIG. 1. The alternative two-axis beam scanner 1300 is identical to the two axis AOM beam scanner 120 described in relation to FIG. 1, except that the first and second lenses 132,133 have been replaced by a half-pitch graded index (GRIN) rod 1324. FIG. 13 depicts the first beam scanner element 130 receiving the pulsed laser beam 150 emitted by the pulsed laser 102 and deflecting (i.e. steering) the pulsed laser beam 150 into one of two deflected rays: an x+ ray 1352, and an x− ray 1353. The x+ ray 1352 has been deflected in the positive x direction by the first scanner element 130. The x− ray 1352 has been deflected in the negative x direction by the first scanner element 130. The x+ ray 1352 and the x− ray 1353 correspond to maximally displaced rays from an optical axis 1360 of the two-axis beam scanner 1300.

In use, the two-axis beam scanner 1300 steers the pulsed laser beam 150 along any direction between the x+ ray 1352 and the x− ray 1353. Unlike the lenses 132, 133 of the two-axis AOM beam scanner 120 described in relation to FIG. 1, the GRIN rod 1324 is a single optical element. Because the GRIN rod 1324 is one single optical element, the GRIN rod 1324 minimizes alignment complexity. The GRIN rod 1324 reduces pulse delay variations between different optical paths through the GRIN rod 1324, which is important for processing the substrate 108 using the ultrafast pulsed laser beam 150. For example, although a ray travelling along the optical axis 1360 has a shorter path than the x+ ray 1352, the ray travelling along the optical axis 1360 passes through area region of the GRIN rod 1324 having a higher refractive index than the region of the GRIN rod 1324 through which the x+ ray 1352 passes.

It should be understood that the different apparatus and methods described above are illustrative only and that the claims are not limited to the apparatus and methods described above. Those skilled in the art will understand that various modifications may be made to the apparatus and methods described above without departing from the scope of the appended claims. For example, although the beam scanner 120 is described above as an AOM beam scanner, the beam scanner 120 may be a non-mechanical beam scanner or a solid state beam scanner of any kind. For example, the beam scanner 120 may be an electro-optic modulation (EOM) beam scanner.

The first beam scanner element 130 of the beam scanner 120 is described above as rotating the pulsed laser beam 150 around the y-axis and the second beam scanner element 134 of the scanner 120 is described as rotating the pulsed laser beam 150 around the x axis. However, in an alternative beam scanner, the first beam scanner element 130 may rotate the pulsed laser beam 150 around the x-axis and the second beam scanner element 134 may rotate the pulsed laser beam 150 around the y axis.

Although the further beam scanner 122 described above is a two-axis beam scanner, the further beam scanner 122 may be a one-axis beam scanner. Although the further beam scanner 122 described above is a galvanometer beam scanner, the further scanner 122 may be a tilted mirror beam scanner.

In each of the methods of modifying a substrate described with reference to FIGS. 4A to 7B, the contribution of the AOM beam scanner 120 to the positions of the different regions of the substrate 108 irradiated by the different laser pulses as a function of time is shown in FIGS. 4B, 5B, 6B and 7B and comprises a corresponding periodic saw-tooth pattern which includes a plurality of teeth, wherein each tooth includes a more gradual positively sloped portion defined by a plurality of positions having values which increase progressively with time followed by a steeper negatively sloped portion. In a variant of any of the methods of modifying a substrate described with reference to FIGS. 4A to 7B, the contribution of the AOM beam scanner 120 to the positions of the different regions of the substrate 108 irradiated by the different laser pulses as a function of time may comprise a corresponding periodic saw-tooth pattern which includes a plurality of teeth, wherein each tooth includes a more gradual negatively sloped portion defined by a plurality of positions having values which decrease progressively with time followed by a steeper positively sloped portion.

In addition to, or as an alternative to, using the faster AOM beam scanner 120 to compensate for any difference between the measured beam steering configuration of the slower galvanometer beam scanner 122 and the intended beam steering configuration of the slower galvanometer beam scanner 122, the timing of the emission of the laser pulses from the pulsed laser 102 may be controlled so as to compensate for any difference between the measured beam steering configuration of the slower galvanometer beam scanner 122 and the intended beam steering configuration of the slower galvanometer beam scanner 122.

The method may comprise moving the substrate 108 in a direction of propagation of the pulsed laser beam 150 and/or in a direction which is opposite to a direction of propagation of the pulsed laser beam 150, for example using the moveable stage 109. Such a method may allow the substrate 108 to be modified in 3D.

Although each region of the substrate 108 is described above as being irradiated by a single laser pulse, one or more of the regions of the substrate 108 may be irradiated by two or more non-consecutive laser pulses.

Although the beam steering arrangement 104 above is described above as including the photodetector 110, the AWG 112, and the controller 114, one or more of these components may be provided with the pulsed laser 102.

Although the pulsed laser 102 is described above as being a pulsed femtosecond laser for emitting a pulsed laser beam 150 in the form of a train of laser pulses with a wavelength in the region of 1035 nm, the pulsed laser may be configured to emit a pulsed laser beam in the form of a train of laser pulses with a wavelength which is greater than 400 nm. For example, the pulsed laser may be configured to emit a pulsed laser beam in the form of a train of laser pulses with a wavelength which is substantially equal to 520 nm, 800 nm, or 1550 nm.

The train of laser pulses may be generated using a Q-switched laser or a mode-locked laser. The train of laser pulses may be generated using a laser in combination with an optical modulator.

Each feature disclosed or illustrated in the present specification may be incorporated in any of the different apparatus and methods described above, either alone, or in any appropriate combination with any other feature disclosed or illustrated herein. One or more of the features of any of the apparatus or methods described above with reference to the drawings may produce effects or provide advantages when used in isolation from one or more of the other features of the same apparatus or method. Different combinations of the features are possible other than the specific combinations of the features of the apparatus and methods described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

1-26. (canceled)

27. An apparatus comprising:
a pulsed laser to generate a pulsed laser beam;
an arrangement of optical elements to receive at least a portion of the pulsed laser beam, the optical elements comprising:
a first two-axis beam scanner element; and
a second two-axis beam scanner element after the first two-axis beam scanner element; and
control circuitry to actuate the first two-axis beam scanner element and the second two-axis beam scanner element to control a direction of the pulsed laser beam from laser pulse to laser pulse so that at least three consecutive laser pulses of the pulsed laser beam sequentially irradiate at least three spatial locations according to a predetermined spatial sequence which defines relative spatial positions, and an order of irradiation, of at least three regions of a substrate.

28. The apparatus of claim 27, wherein the first two-axis beam scanner element is a two-axis acousto-optic modulator (AOM) beam scanner element comprising a first one-axis AOM beam scanner element to control a direction of the pulsed laser beam in a first direction and a second one-axis AOM beam scanner element to control a direction of the pulsed laser beam in a second direction.

29. The apparatus of claim 28, wherein the first direction and the second direction are orthogonal.

30. The apparatus of claim 28, further comprising a first lens and a second lens between the first one-axis AOM beam scanner element and the second one-axis AOM beam scanner element, wherein the first lens is one focal length distance from the first one-axis AOM beam scanner element, the second lens is two focal lengths distance from the first lens, and the second one-axis AOM beam scanner element is one focal length distance from the second lens.

31. The apparatus of claim 27, wherein the arrangement of optical elements further comprises a first lens and a second lens between the first two-axis beam scanner element and the second two-axis beam scanner element.

32. The apparatus of claim 31, wherein the first lens is one focal length distance from the first two-axis beam scanner element, the second lens is two focal lengths distance from the first lens, and the second two-axis beam scanner element is one focal length distance from the second lens.

33. The apparatus of claim 27, wherein the second two-axis beam scanner element is a two-axis galvanometer beam scanner.

34. The apparatus of claim 27, wherein the arrangement of optical elements further comprises a microscope objective and an optical relay system between the second two-axis beam scanner element and the microscope objective.

35. The apparatus of claim 34, wherein the optical relay system comprises a first lens that is one focal length distance from the second two-axis beam scanner element, the second lens is two focal lengths distance from the first lens, and the microscope objective is one focal length distance from the second lens.

36. The apparatus of claim 27, wherein the pulsed laser is to generate a train of periodic laser pulses with a repetition rate of at least 100 KHz.

37. The apparatus of claim 27, wherein the pulsed laser comprises a Q-switched laser or a mode-locked laser.

38. A system comprising:
a pulsed laser to generate a pulsed laser beam;
a beamsplitter to receive the pulsed laser beam;
an arrangement of optical elements to receive a first portion of the pulsed laser beam from the beamsplitter, the optical elements comprising:
a first two-axis beam scanner element;
a second two-axis beam scanner element after the first two-axis beam scanner element; and
a microscope objective after the second two-axis beam scanner element;
a stage to house a substrate, the stage positioned such that a substrate coupled to the stage receives pulsed laser beam from the arrangement of optical elements;
a photodetector to receive a second portion of the pulsed laser beam; and
control circuitry to actuate the first two-axis beam scanner element and the second two-axis beam scanner element based on signals from the photodetector.

39. The system of claim 38, wherein the control circuitry is to actuate the first and second two-axis beam scanner elements to control a direction of the pulsed laser beam from laser pulse to laser pulse so that at least three consecutive laser pulses sequentially irradiate at least three regions of the substrate according to a predetermined spatial sequence which defines relative spatial positions, and an order of irradiation, of the at least three regions of the substrate.

40. The system of claim 38, wherein the control circuitry is further to control a position of the stage from laser pulse to laser pulse so that at least three consecutive laser pulses sequentially irradiate at least three regions of the substrate according to a predetermined spatial sequence which defines relative spatial positions, and an order of irradiation, of the at least three regions of the substrate.

41. The system of claim 38, wherein the control circuitry is to:
control a direction of the pulsed laser beam or a position of the substrate so as to move a nominal writing position of the pulsed laser beam to a first position in the substrate so that a first one of at least three consecutive laser pulses irradiates a first region of the substrate centered on the first position;
control a direction of the pulsed laser beam or a position of the substrate so as to move the nominal writing position of the pulsed laser beam across the substrate along a first direction from the first position in the substrate to a second position in the substrate so that a second one of the at least three consecutive laser pulses irradiates a second region of the substrate centered on the second position; and
control a direction of the pulsed laser beam or a position of the substrate so as to move the nominal writing position of the pulsed laser beam across the substrate along a second direction from the second position in the substrate to a third position in the substrate so that a third one of the at least three consecutive laser pulses irradiates a third region of the substrate centered on the third position, wherein the first and second directions are different.

42. A method comprising:
generating a pulsed laser beam comprising a train of laser pulses, the train of laser pulses including at least three consecutive laser pulses; and
sequentially irradiating at least three regions of a substrate with the at least three consecutive laser pulses so as to modify the substrate according to a desired spatial profile, wherein modifying the substrate comprises at least one of modifying a refractive index of a material of the substrate, modifying a chemical etchability of the material of the substrate, or ablating the material of the substrate; and
controlling a direction of the pulsed laser beam or a position of the substrate from laser pulse to laser pulse so that the at least three consecutive laser pulses sequentially irradiate the at least three regions of the substrate according to a predetermined spatial sequence which defines relative spatial positions of at least three regions of the substrate and defines an order of irradiation of the at least three regions of the substrate.

43. The method of claim 42, wherein controlling the direction of the pulsed laser beam and/or the position of the substrate comprises synchronizing a movement of the pulsed laser beam and/or of the substrate with the timing of the at least three consecutive laser pulses so that the at least three regions of the substrate are sequentially irradiated with the at least three consecutive laser pulses according to the predetermined spatial sequence.

44. The method of claim 42, wherein controlling the direction of the pulsed laser beam or the position of the substrate comprises:
controlling movement of the pulsed laser beam or of the substrate so as to move a nominal writing position of the pulsed laser beam to a first position in the substrate so that a first one of the at least three consecutive laser pulses irradiates a first region of the substrate centered on the first position;
controlling movement of the pulsed laser beam or of the substrate so as to move the nominal writing position of the pulsed laser beam across the substrate along a first direction from the first position in the substrate to a second position in the substrate so that a second one of the at least three consecutive laser pulses irradiates a second region of the substrate centered on the second position; and
controlling movement of the pulsed laser beam or of the substrate so as to move the nominal writing position of the pulsed laser beam across the substrate along a second direction from the second position in the substrate to a third position in the substrate so that a third one of the at least three consecutive laser pulses irradiates a third region of the substrate centered on the third position, wherein the first and second directions are different.

45. The method of claim 42, comprising:
determining or measuring emission timing data for one or more of the laser pulses;
determining or measuring a nominal writing position of the pulsed laser beam in the substrate and/or determining or measuring a velocity of the nominal writing position of the pulsed laser beam across the substrate;
calculating a predicted nominal writing position of the pulsed laser beam in the substrate at a time of emission of a future laser pulse on the substrate using the determined or measured emission timing data and at least one of the determined or measured nominal writing position of the pulsed laser beam in the substrate and the determined or measured velocity of the nominal writing position of the pulsed laser beam across the substrate; and
compensating for any difference between the predicted nominal writing position of the pulsed laser beam in the substrate and a corresponding desired future nominal writing position of the pulsed laser beam in the substrate by controlling a beam steering configuration of a beam scanner and/or a rate of change of the beam steering configuration of the beam scanner, to compensate for any difference between the predicted nominal writing position of the pulsed laser beam in the substrate and the desired future nominal writing position of the pulsed laser beam in the substrate.

46. The method of claim 42, comprising:
determining or measuring emission timing data for one or more of the laser pulses;
determining or measuring a beam steering configuration such as one or more tilt angles of a slower beam scanner and/or determining or measuring a rate of change of a beam steering configuration such as a rate of change of the one or more tilt angles of the slower beam scanner;
calculating a predicted beam steering configuration of the slower beam scanner at a time of emission of a future laser pulse using the determined or measured emission timing data and at least one of the determined or measured beam steering configuration of the slower beam scanner and the determined or measured rate of change of the beam steering configuration of the slower beam scanner; and
using a faster beam scanner to compensate for any difference between the predicted beam steering configuration of the slower beam scanner and a corresponding desired beam steering configuration of the slower beam scanner at the time of emission of the future laser pulse, for example by controlling a beam steering configuration of the faster beam scanner and/or a rate of change of the beam steering configuration of the faster beam scanner to compensate for any difference between the predicted beam steering configuration of the slower beam scanner and a corresponding desired beam steering configuration of the slower beam scanner at the time of emission of the future laser pulse.
